(19) United States
(12) Patent Application Publication
(10) Pub. No.: US 2005/0175007 A1
(43) Pub. Date: Aug. 11, 2005

(54) Method, medium, and apparatus for assuring duplicate address detection

(75) Inventors: Soo-hong Park, Yongin-si (KR); Young-keun Kim, Incheon Metropolitan City (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/050,736

(22) Filed: Feb. 7, 2005

(30) Foreign Application Priority Data
Feb. 5, 2004 (KR) 2004-7668

(51) Int. Cl. H04L 12/56

(52) U.S. Cl. 370/390

(57) ABSTRACT

A method, medium, and apparatus for assuring duplicate address detection. The method includes: determining whether a predetermined packet is related to a duplicate address detection, and if the packet is determined to be related to the duplicate address detection, modifying a source address of the predetermined packet to another predetermined address different from the source address. Proper duplicate address detection can be assured even in an environment where multicast packet filtering is based on a link layer source address that follows the IEEE 802.11 standard.

### CROSS-REFERENCE TO RELATED APPLICATIONS

This application claims the benefit of Korean Patent Application No. 2004-7668, filed on Feb. 5, 2004, in the Korean Intellectual Property Office, the disclosure of which is incorporated herein in its entirety by reference.

### BACKGROUND OF THE INVENTION

1. Field of the Invention

The present invention relates to detecting a duplicate address in an Internet Protocol version 6 (IPv6) wireless local area network (LAN) environment, and more particularly, to a method, medium, and apparatus for assuring duplicate address detection.

2. Description of the Related Art

FIG. 1 is a view of movements of packets and frames related to conventional duplicate address detection. Referring to FIG. 1, the packet related to the duplicate address detection reaches a basic service set (BSS) via an access router 3 connected to a wired network and an access point 2 connected to the access router 3. The BBS is used in the IEEE 802.11 standard and regulates a link layer, denoted by an area in which wireless communication is possible based on one access point. A mobile node 1, within the BSS, includes a protocol stack having a lower layer 11, a link layer 12, an Internet Protocol (IP) layer 13, and a higher layer 14. If an IPv6 protocol stack is mounted in the IP layer 13, the mobile node 1 may communicate in the IPv6 with another node, also having the Ipv6 protocol stack mounted therein. That is, the mobile node 1 may perform duplicate address detection according to a mobile IPv6 standard. Herein, the mobile node 1 is described as being in accordance with the mobile IPv6 standard and is also known as a “station” in the IEEE 802.11 standard.

In the duplicate address detection operation, it is determined whether a desired address for a node is already being used by another node. The first node performing the duplicate address detection transmits a neighbor solicitation message to the second node, and the second node, upon receipt of the neighbor solicitation message, transmits a neighbor advertisement message to the first node, based on the results of the duplicate address detection. The neighbor solicitation and advertisement messages are a form of an Internet control message protocol (ICMP), with illustrated frames 121 and 122 and packets 131 and 132 including such ICMP messages.

In the conventional process of duplicate address detection, first, the mobile node 1, which generates the only global address in a global area network, receives a network prefix from the access router 3 via the access point 2. The network prefix is a prefix designated to networks throughout to distinguish each network. Then, the mobile node 1 generates the global address using the network prefix, or generates only the local address in a local network using a predetermined prefix (FE80::/64 according to the IPv6 standard). Here, the generated address is used as a tentative address until its uniqueness is proven. The mobile node 1 assigns the tentative address as a target address for duplicate address detection and multicasts an appropriate neighbor solicitation message to all nodes within the BSS, when the tentative address is the local address, and to all nodes in the global network, when the tentative address is the global address. A node that uses the identical address as the target address, among the nodes which received the neighbor solicitation message, transmits a corresponding neighbor advertisement including the target address to mobile node 1. Therefore, when the mobile node 1 receives the neighbor advertisement message, it will be known whether the generated address is a duplicate address, thereby requiring the user to use a different address other than the duplicate address as the user's address.

Besides the above-described method, another node other than the mobile node 1 may, almost simultaneously, perform a similar duplicate address detection. Again, when the mobile node 1 receives the aforementioned neighbor solicitation message including the target address identical to its tentative address, from the aforementioned second node, it may be determined that the tentative address is already in use.

However, according to the IEEE 802.11 standard, the access point 2, which received the broadcast or multicast messages from the mobile node 1 within the BSS, transmits the received messages to another access point and node according to a broadcast or multicast process. In this process, the mobile node 1 also receives the broadcast or multicast messages that it transmitted, which is known as “loop-back.” Therefore, all mobile nodes filter broadcast or multicast messages with a link layer source address identical to its link layer source address. Through this, problems in filtering the neighbor solicitation and advertisement messages arise. As a result, the duplicate address detection may not performed properly.

### SUMMARY OF THE INVENTION

Embodiments of the present invention provide a method, medium, and apparatus for assuring proper duplicate address detection in a multicast filtering environment based on a link layer source address which follows an IEEE 802.11 standard.

Additional aspects and/or advantages of the invention will be set forth in part in the description which follows and, in part, will be obvious from the description, or may be learned by practice of the invention.

To achieve the above and/or other aspects and advantages, embodiments of the present invention include a method of assuring duplicate address detection, the method including comparing a received number of received packets related to a duplicate address detection operation and a transmitted number of packets to be transmitted, and identifying a target address of a node to be a duplicate address of another node if the received number is greater than the transmitted number.

The method may further include determining whether a predetermined address of the node is already used by the other node based on the identified duplicate target address.

The packet may be extracted from a frame including a link layer source address identical to a predetermined link layer source address in an environment where a multicast packet filtering is disabled based on the link layer source address. In addition, the method may further include incrementing the received number whenever a received packet is determined as being related to duplicate address detection for the node, and incrementing the transmitted number whenever a packet to be transmitted is determined as being related to the duplicate address detection for the node.

This incrementing of the received number may include determining the packet to be related to the duplicate address detection if an unspecified address is recorded in a source address field, included in a header of the received packet, or if a source address, included in the header of the received packet, is identical to the target address.

Similarly, the incrementing of the transmitted number may include determining the packet to be related to the duplicate address detection if an unspecified address is recorded in a source address field, included in a header of the packet to be transmitted.

To achieve the above and/or other aspects and advantages, embodiments of the present invention include an apparatus for assuring duplicate address detection, the apparatus including a comparator comparing a received number of packets related to a duplicate address detection and a transmitted number packets to be transmitted, and a duplicate address decider deciding that a target address of a node is a duplicate address of another node if the received number is greater than the transmitted number.

The duplicate address decider may determine an address of the node is already used by the other node. In addition, a packet may be extracted from a frame including a link layer source address identical to a predetermined link layer source address in an environment where a multicast packet filtering is disabled based on the link layer source address.

Further, the apparatus may include a packet receiving counter for incrementing the received number whenever a received packet is determined as being related to duplicate address detection for the node, and a packet transmitting counter for incrementing the transmitted number whenever a packet to be transmitted is determined as being related to the duplicate address detection for the node.

To achieve the above and/or other aspects and advantages, embodiments of the present invention include a method of assuring duplicate address detection, the method including determining whether a predetermined packet is related to a duplicate address detection for a node, and modifying a source address of the predetermined packet to another predetermined address, different from the source address, if the predetermined packet is determined as being related to the duplicate address detection for the node.

The method may further include detecting whether an address of the node is already used by another node based on the modified source address.

The source address may be a link layer source address. In addition, the determining may further include determining the predetermined packet to be related to the duplicate address detection if an unspecified address is recorded in a source address field, included in a header of the predetermined packet, or if the source address included in the header of the packet is identical to a target address of the node.

The method may further include generating a frame including the predetermined packet, having the predetermined address as the source address, and transmitting the generated frame.

To achieve the above and/or other aspects and advantages, embodiments of the present invention include an apparatus for assuring duplicate address detection, the apparatus including a packet determiner for determining whether a predetermined packet is related to a duplicate address detection for a node, and a source address modifier for modifying a source address of the predetermined packet to another predetermined address, different from the source address, if the predetermined packet is determined as being related to the duplicate address detection for the node.

The apparatus may determine whether an address of the node is already used by another node. In addition, the source address may be a link layer source address.

The packet determiner may determine the predetermined packet is related to the duplicate address detection if an unspecified address is recorded in a source address field, included in a header of the predetermined packet, or if the source address, included in the header of the predetermined packet, is identical to a target address for the node.

To achieve the above and/or other aspects and advantages, embodiments of the present invention include a medium including computer readable code implementing methods of the present invention.

In addition to the above, in embodiments of the present invention, received packets may adhere to an Internet Protocol Version 6. Similarly, the predetermined packet may adhere to an Internet Protocol Version 6.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates movements of packets and frames related to a conventional duplicate address detection;

FIG. 2 illustrates a format of a frame, including a neighbor solicitation message used in a duplicate address detection operation;

FIG. 3 illustrates a frame format including a neighbor advertisement message used in a duplicate address detection operation;

FIG. 4 illustrates an apparatus for assuring duplicate address detection, according to an embodiment of the present invention;

FIG. 5 illustrates an apparatus for assuring duplicate address detection, according to another embodiment of the present invention;

FIG. 6 is a flowchart of a method of assuring duplicate address detection, according to an embodiment of the present invention; and

FIG. 7 is a flowchart of another method of assuring duplicate address detection, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

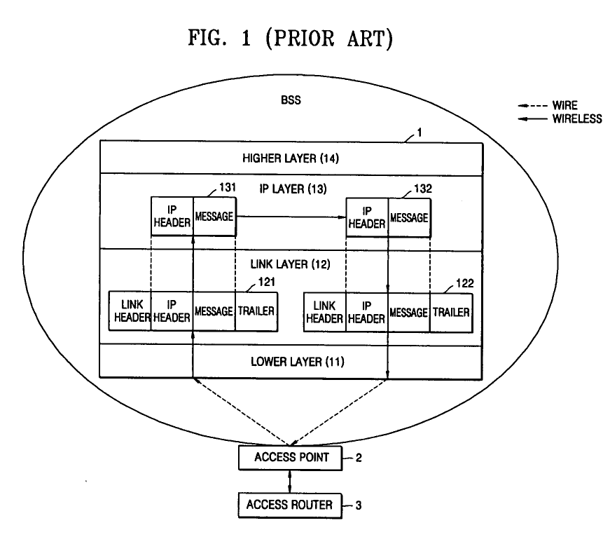

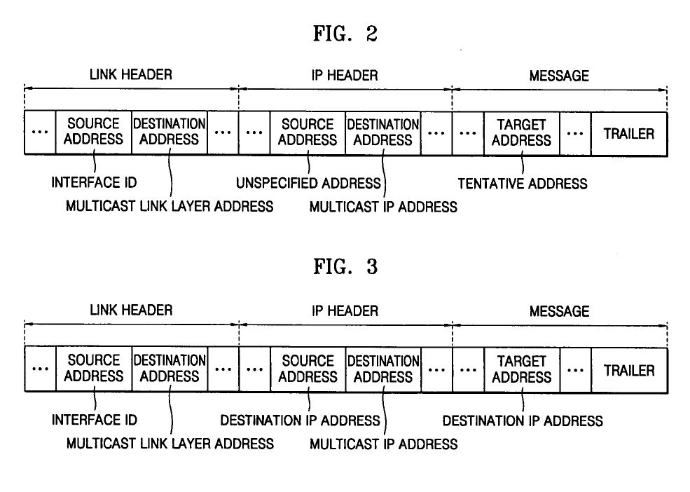

FIG. 2 illustrates a format of a frame including a neighbor solicitation message used in duplicate address detection operation. Referring to FIG. 2, the illustrated frame including a neighbor solicitation message, used in the duplicate address detection, includes a detailed view of frames 121 and 122 of FIG. 1. The frame includes a link header, an Internet Protocol (IP) header, an Internet control message protocol (ICMP), and a trailer. The link header includes a source address field, with an interface identification (ID), and a destination address field, with a multicast link layer address. The IP header includes a source address field, with an unspecified address, and a source address field, with a multicast IP address. The ICMP message includes a target address, with a tentative address. A problem that causes the aforementioned improper performance of the duplicate address detection operation is understood to be as follows.

The tentative address is generated based on the interface ID of a network interface attached to a corresponding node, wherein the interface ID is a link layer address. That is, a global address is generated by a network prefix+the interface ID, and a local address is generated as FE80::/64 interface ID. Therefore, when an address that a plurality of nodes may want to use is identical, the interface ID is identical, which means the link layer address is identical. Strictly speaking, the length of the interface ID used for generating the length and address of the interface ID, as the link layer address, may be different according to the standard. However, the content is fundamentally the same and the stated logic is similarly valid.

As described above, according to the IEEE 802.11 standard, all mobile nodes filter broadcast or multicast messages having a link layer source address identical to its own address. Since the link layer source address of the frame carrying the neighbor solicitation message, which has the target address identical to its tentative address, is identical to its link layer source address, the neighbor solicitation message is filtered at a link layer level. Therefore, the IP layer has not even received the packet, since the frame including a packet that includes the neighbor solicitation message is discarded at an IP layer, which is a higher layer.

FIG. 3 illustrates another frame format including a neighbor advertisement message used in a duplicate address detection operation. Referring to FIG. 3, the illustrated frame including the neighbor advertisement message, used for the duplicate address detection, includes detailed view of frames 121 and 122 of FIG. 1. The frame includes of a link header, an IP header, an ICMP, and a trailer. The link header includes a source address field, with an interface ID, and a destination address field, with a multicast link layer address. The IP header includes a source address field, with destination IP address, and a source address field, with a multicast IP address. The ICMP message includes a target address, with a destination IP address. Regarding the neighbor advertisement message, the problem that causes the aforementioned improper performance of the duplicate address detection is understood to be as follows:

As described-above, the fact that an address that plurality of nodes may want to use is identical means that the corresponding interface ID is identical, which means the link layer address is also identical. Thus, the IP layer has not even received the packet, since the frame including a packet that includes the neighbor solicitation message is discarded at an IP layer, which is a higher layer.

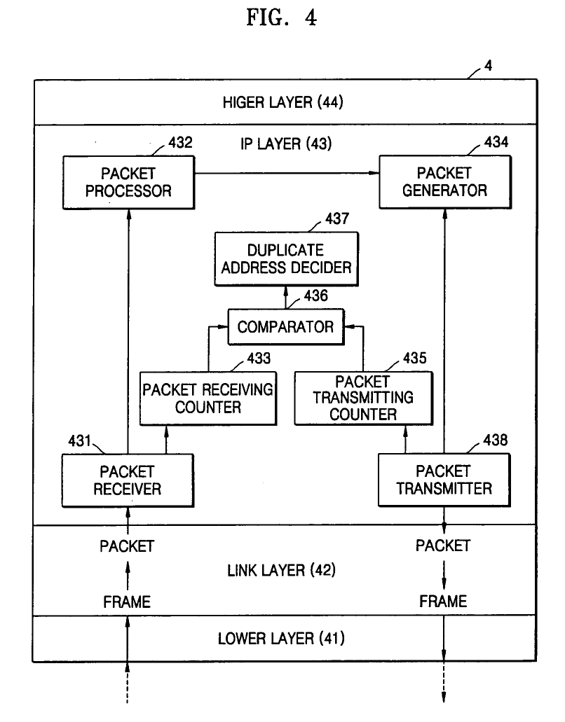

FIG. 4 illustrates an apparatus for assuring duplicate address detection, according to an embodiment of the present invention. Referring to FIG. 4, a node 4 may include a lower layer 41, a link layer 41, an IP layer 43, and a higher layer 44. This apparatus for assuring duplicate address detection, mounted in the IP layer 43, includes a packet receiver 431, a packet processor 432, a packet receiving counter 433, a packet generator 434, a packet transmitting counter 435, a comparator 436, a duplicate address decider 437, and a packet transmitter 438. In the present embodiment, an underlying premise is that multicast packet filtering can be disabled based on a link layer source address of the IEEE 802.11 standard, such that a mobile node can again receive all packets the mobile node has multicasted.

The packet receiver 431 receives a packet from the link layer 42. The packet processor 432 processes the packet based on information included in a header of the packet. Here, the packet is extracted from a frame including a link layer source address identical to a link layer source address of the node 4, in an environment where the multicast packet filtering is disabled based on a link layer source address. That is, the packet can be extracted from a frame including the link layer source address identical to the link layer source address of the node 4 or can be received unfiltered, according to this embodiment of the present embodiment, which also applies to the packet mentioned below.

The packet receiving counter 433 increments a count whenever the packet receiver 431 receives a packet that is determined to be related to the duplicate address detection. That is, the packet receiving counter 433 increments the count by one whenever the neighbor solicitation or advertisement messages are received from another node having an identical link layer source address. Here, the packet receiving counter 433 determines that the packet is related to the duplicate address detection if an unspecified address is recorded in the source address field, included in the header of the packet, or if the value recorded on the source address field, included in the header of the packet, is the same as the value recorded on the target address field.

According to the Internet Protocol version 6 (IPv6) standard, the unspecified address (i.e., ::) is recorded in the source address field of the packet including the neighbor solicitation message, and in the neighbor advertisement message, notifying the detection of the duplicate address already being used by another node, with the value recorded on the source address field included in the header of the neighbor advertisement message and the value recorded on the target address field is the same.

The packet generator 434 generates a packet including the neighbor solicitation message that requests the duplicate address detection, based on the result of the packet processor 432. That is, the neighbor solicitation message is generated when the packet processed by the packet processor 432 includes a router advertisement message, including a network prefix (provided that the global address is generated). Because the ICMP message is processed at the IP layer 43, the packet generator 434 generates a packet to be transmitted straight away, without having to transmit data to the higher layer 44. The packet transmitter 438 transmits the packet generated at the packet generator 434 to the link layer 42.

The packet transmitting counter 435 increments the count whenever the packet to be transmitted is determined to be the packet related to the duplicate address detection. That is, the packet transmitting counter 435 increments the count by one whenever the packet, including the neighbor solicitation message requesting the duplicate address detection, is being transmitted. Here, the packet transmitting counter 435 determines that the packet is related to the duplicate address detection if an unspecified address is recorded on the source address field.

The comparator 436 compares the count of the packet receiving counter 433 and the count of the packet transmitting counter 435. In other words, the number of received packets related to the duplicate address detection and the to be transmitted number of packets related to the duplicate address detection are compared. The duplicate address decider 437 decides that the target address of the duplicate address is a duplicate if the result of the comparison at the comparator 436 indicates that the number of the received packets is higher than the packets to be transmitted. It will be assumed, in the present embodiment, that the environment is one which disables the multicast packet filtering based on the link layer source address of the IEEE 802.11 standard and the mobile node thereby receives all packets the mobile node has multicasted. Therefore, in the case where the node 4 has transmitted the neighbor solicitation message 3 times, if the node 4 did not transmit the neighbor solicitation message or the neighbor advertisement message, the node 4 transmits the neighbor advertisement message 3 times, for example. However, if another node has transmitted a neighbor solicitation message or the neighbor advertisement message with the identical address as the target, the total number of the neighbor solicitation or advertisement messages, which have an address identical to the address the other node has generated as the target address, is higher than the number of transmitted neighbor solicitation messages. The address the duplicate address decider 437 decided as being the duplicate address is then set to be a different address manually by a user.

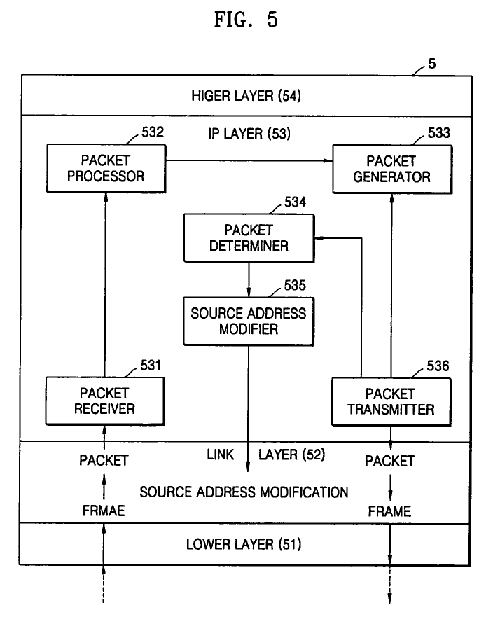

FIG. 5 is a view of a second apparatus, according to another embodiment of the present invention. Referring to FIG. 5, a node 5 includes a lower layer 51, a link layer 51, an IP layer 53, and a higher layer 54. This second apparatus for assuring duplicate address detection mounted in the IP layer 53 includes a packet receiver 531, a packet processor 532, a packet generator 533, a packet determiner 534, a source address modifier 535, and a packet transmitter 436. In the present embodiment as presented above, the assumption is that the environment is one in which a multicast packet filtering can be disabled based on a link layer source address of the IEEE 802.11 standard and a mobile node may again receive all packets the mobile node has multicasted. The assumption in the case of the aforementioned previous apparatus for assuring duplicate address detection of FIG. 4 is the environment where the multicast packet filtering is disabled based on the link layer source address of the IEEE 802.11 standard so that the mobile node again receives all the packets it multicasted. However, when considering randomness and instability of hte wireless local area network (LAN) environments, the aforementioned apparatus related to FIG. 4, for assuring duplicate address detection, may not be a perfect solution. The following apparatus for assuring duplicate address detection may be another solution.

In this embodiment, the packet receiver 531 receives a packet from the link layer 52. The packet processor 532 processes the packet based on information included in the header of the packet. The packet generator 533 generates a packet including the neighbor solicitation message or a neighbor advertisement message based on the results of the packet processor. 532. The former packet generation is when the message included in the packet processed at the packet processor 532 is a router advertisement message, and the latter packet generation is when the message included in the packet processed at the packet processor 532 is the neighbor solicitation message. The packet transmitter 536 transmits the packet generated at the packet generator 533 to the link layer 52.

The packet determiner 534 determines whether the packet to be transmitted from the packet transmitter 536 is a packet related to the duplicate address detection. Here, the packet determiner 534 determines that the packet is related to the duplicate address detection if the an unspecified address is recorded in a source address field, or if the value recorded on the source address field and the value recorded in a target address field is the same.

The source address modifier 535 modifies a link layer source address of the packet transmitted from the packet transmitter 536 into another address, different from the link layer source address, if the packet is determined to be the packet related to the duplicate address detection, in the packet determiner 534. For example, the source address may be modified into an unspecified address (::). If so, a link layer source address of the returned neighbor solicitation message, or a neighbor solicitation, or advertisement message transmitted from another node will not be the same as the link layer address of itself, thereby not filtering the neighbor solicitation and advertisement messages. As a result, proper duplicate address detection can be assured.

The link layer 52 generates a frame including the packet, having the modified address modified by the source address modifier 535 as the link layer source address, and transmits the generated frame to the lower layer 51.

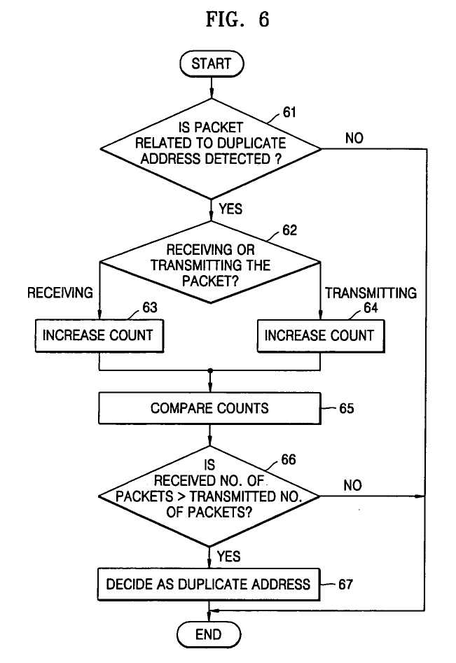

FIG. 6 is a flowchart of a method for assuring duplicate address detection. Referring to FIG. 6, this method of assuring duplicate address detection corresponds to the apparatus for assuring duplicate address detection, referenced above regarding FIG. 4, and thus the above discussion regarding FIG. 4 should be referred to for details omitted below.

First, whenever a received packet is determined to be a packet related to a duplicate address detection (Operation 61 and 62), a count is incremented (Operation 63). At the same time, whenever a packet to be transmitted is determined to be a packet related to the duplicate address detection (Operation 61 and 62), another count is incremented (Operation 64). Then, the counting of Operations 63 and 64 are compared. That is, the number of the received packets related to the duplicate address detection and the number of packets related to the duplicate address detection that are to be transmitted are compared. If the number of the received packets is higher than the number of packets to be transmitted, it is determined that the target address of the duplicate address detection is already in use by another node (Operation 67).

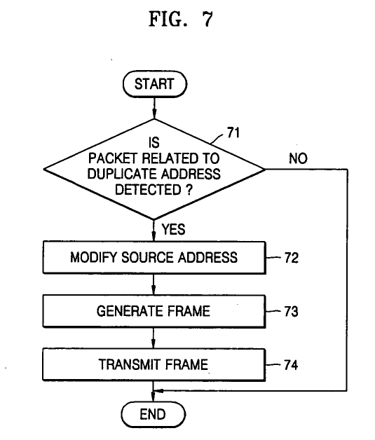

FIG. 7 is a flowchart of another method of assuring duplicate address detection. Referring to FIG. 7, this method of assuring duplicate address detection corresponds to the apparatus for assuring duplicate address detection discussed above regarding FIG. 5, and thus FIG. 5, and the related discussions, should be referred to for details omitted below.

First, it is determined whether a received packet is related to a duplicate address detection (Operation 71). If the packet is determined to be related to the duplicate address detection, then modify a source address of the packet into another predetermined address (Operation 72). Then, a frame including the packet with the modified predetermined address as its source address is generated (Operation 73). Then, the generated frame is transmitted (Operation 74).

Embodiments of the present invention can be implemented as computer readable code and can be implemented in general-use digital computers using a medium, e.g., a computer readable recording medium. Examples of the media include magnetic storage media (e.g., ROM, floppy disks, hard disks, etc.), optical recording media (e.g., CD-ROMs, or DVDs), and storage media such as carrier waves (e.g., transmission through the Internet), for example. According to the above, embodiments of the present invention can assure proper duplicate address detection by disabling multicast packet filtering based on a link layer source address that follows an IEEE 802.11 standard. In addition, a proper duplicate address detection is assured also by performing multicast packet filtering based on the link layer source address that follows the IEEE 802.11 standard.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of assuring duplicate address detection, the method comprising:
comparing a received number of received packets related to a duplicate address detection operation and a transmitted number of packets to be transmitted; and
identifying a target address of a node to be a duplicate address of another node if the received number is greater than the transmitted number.

2. The method of claim 1, further comprising determining whether a predetermined address of the node is already used by the other node based on the identified duplicate target address.

3. The method of claim 1, wherein a packet is extracted from a frame including a link layer source address identical to a predetermined link layer source address in an environment where a multicast packet filtering is disabled based on the link layer source address.

4. The method of claim 1, comprising:
incrementing the received number whenever a received packet is determined as being related to duplicate address detection for the node; and
incrementing the transmitted number whenever a packet to be transmitted is determined as being related to the duplicate address detection for the node.

5. The method of claim 4, wherein the incrementing of the received number includes determining the packet to be related to the duplicate address detection if an unspecified address is recorded in a source address field, included in a header of the received packet, or if a source address, included in the header of the received packet, is identical to the target address.

6. The method of claim 4, wherein the incrementing of the transmitted number includes determining the packet to be related to the duplicate address detection if an unspecified address is recorded in a source address field, included in a header of the packet to be transmitted.

7. An apparatus for assuring duplicate address detection, the apparatus comprising:
a comparator comparing a received number of packets related to a duplicate address detection and a transmitted number packets to be transmitted; and
a duplicate address decider deciding that a target address of a node is a duplicate address of another node if the received number is greater than the transmitted number.

8. The apparatus of claim 7, wherein the duplicate address decider determines an address of the node is already used by the other node.

9. The apparatus of claim 7, wherein a packet is extracted from a frame including a link layer source address identical to a predetermined link layer source address in an environment where a multicast packet filtering is disabled based on the link layer source address.

10. The apparatus of claim 7, comprising:
a packet receiving counter for incrementing the received number whenever a received packet is determined as being related to duplicate address detection for the node; and
a packet transmitting counter for incrementing the transmitted number whenever a packet to be transmitted is determined as being related to the duplicate address detection for the node.

11. A method of assuring duplicate address detection, the method comprising:
determining whether a predetermined packet is related to a duplicate address detection for a node; and
modifying a source address of the predetermined packet to another predetermined address, different from the source address, if the predetermined packet is determined as being related to the duplicate address detection for the node.

12. The method of claim 11, further comprising detecting whether an address of the node is already used by another node based on the modified source address.

13. The method of claim 11, wherein the source address is a link layer source address.

14. The method of claim 11, wherein the determining further comprises determining the predetermined packet to be related to the duplicate address detection if an unspecified address is recorded in a source address field, included in a header of the predetermined packet, or if the source address included in the header of the packet is identical to a target address of the node.

15. The method of claim 11, comprising:
generating a frame including the predetermined packet, having the predetermined address as the source address; and
transmitting the generated frame.

16. An apparatus for assuring duplicate address detection, the apparatus comprising:
a packet determiner for determining whether a predetermined packet is related to a duplicate address detection for a node; and
a source address modifier for modifying a source address of the predetermined packet to another predetermined address, different from the source address, if the predetermined packet is determined as being related to the duplicate address detection for the node.

17. The apparatus of claim 16, wherein the apparatus determines whether an address of the node is already used by another node.

18. The apparatus of claim 16, wherein the source address is a link layer source address.

19. The apparatus of claim 16, wherein the packet determiner determines the predetermined packet is related to the duplicate address detection if an unspecified address is recorded in a source address field, included in a header of the predetermined packet, or if the source address, included in the header of the predetermined packet, is identical to a target address for the node.

20. A medium comprising computer readable code implementing a method of assuring duplicate address detection, the method comprising:
comparing a received number of received packets related to a duplicate address detection for a node and a transmitted number of packets to be transmitted; and
identifying a target address of the node to be a duplicate address of another node if the received number is greater than the transmitted number.

21. A medium computer readable code implementing a method of assuring duplicate address detection, the method comprising:
determining whether a predetermined packet is related to a duplicate address detection for a node; and
modifying a source address of the predetermined packet to another predetermined address, different from the source address, if the predetermined packet is determined as being related to the duplicate address detection for the node.

22. The method of claim 1, wherein received packets adhere to an Internet Protocol Version 6.

23. The method of claim 11, wherein the predetermined packet adheres to an Internet Protocol Version 6.

24. The apparatus of claim 7, wherein received packets adhere to an Internet Protocol Version 6.

25. The apparatus of claim 16, wherein the predetermined packet adheres to an Internet Protocol Version 6.
